(19) United States
(12) Patent Application Publication
(10) Pub. No.: US 2014/0284903 A1
(43) Pub. Date: Sep. 25, 2014

(54) Pit Pal

(71) Applicant: Beverly Elaine Smith, Houston, TX (US)

(72) Inventor: Beverly Elaine Smith, Houston, TX (US)

(21) Appl. No.: 13/938,102

(22) Filed: Jul. 9, 2013

Related U.S. Application Data
(60) Provisional application No. 61/670,204, filed on Jul. 11, 2012.

(51) Int. Cl. B62B 5/00; B62B 3/02

(52) U.S. Cl. CPC B62B 5/00; B62B 3/02
USPC 280/651; 280/47.34

(57) ABSTRACT

A wheeled cart that is meant to house all the accouterments necessary to the act of outdoor cooking to consolidate all the items used when barbecuing into one convenient unit, while also liberating the user from frequent trips inside the house to gather further necessities.

### PRIORITY CLAIMS REQUEST

The present disclosure claims priority to an is a conversion of U.S. Provisional Patent application No. 61670204 entitled (Pit Pal) and filed Jun. 11, 2012, the entity of which is incorporated by regulations for all purposes.

### BACKGROUND OF THE INVENTION

1. Field of Invention

The present invention relates to the field of carts and more specifically relates to a wheeled cart that is meant to house all the accouterments necessary to the act of outdoor cooking to consolidate all the items used when barbecuing into one convenient unit, which can be easily folded presenting a much thinner profile making it easy to store out of the way while also liberating the user from frequent trips inside the house to gather further necessities.

2. Description of the Related Art

The location of the grill is often quite far removed from the home kitchen, and so all the various tools, seasonings, condiments and other cooking accouterments one requires must be transported outside. Various different grill tools are also required, including spatulas, wire brushes, tongs and barbecue forks. Numerous different sauces and seasonings can be called for, as well as water to quickly put out any fires. It's also handy to have a few towels on hand, along with oven mitts. Fitting all those elements on a regular barbecue shelf is nigh impossible.

Various attempts have been made to solve problems found in food service cart art. Among these are found in: U.S. Pat. No. 2,841,407 to Victor P. Araao et al; U.S. Pat. No. 6,651,456 to Robert White et al; and U.S. Pat. No. 5,048,857 to Kenneth V. Stevens. This art is representative of food service carts.

None of the above inventions and patents, taken either singly or in combination, is seen to describe the invention as claimed. Thus, a need exists for a reliable mobile multi storage utility cart that is meant to house all the accouterments necessary to the act of outdoor cooking to consolidate all the items used when barbecuing into one convenient unit, while also liberating the user from frequent trips inside the house to gather further necessities.

### SUMMARY OF THE INVENTION

In view of the foregoing disadvantages inherent in the known cart device art, the present invention provides a novel mobile multi storage utility cart. The general purpose of the present invention, which will be described subsequently in greater detail, is to provide a wheeled cart that is meant to house all the accouterments necessary to the act of outdoor cooking to consolidate all the items used when barbecuing into one convenient unit, while also liberating the user from frequent trips inside the house to gather further necessities. The features of the invention which are believed to be novel are particularly pointed out and distinctly claimed in the concluding portion of the specification. These and other features, aspects and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Pit Pal, constructed and operative according to the teachings of the present invention.

FIG. 1A, FIG. 1B, FIG. 1C, FIG. 1D are perspective views illustrating a mobile multi storage utility cart referred to as Pit Pal according to an embodiment of the present invention.

The various embodiments of the present invention will hereinafter be described in conjunction with the appended drawings.

Drawings-Reference Numerals

| | |
|---|---|
| 1 | vertical structural elements |
| 2 | base |
| 3 | shelves |
| 4 | plastic fitting |
| 5 | plastic wheel |
| 6 | brakes |
| 7 | handle |
| 8 | front basket with compartments |
| 9 | rear basket |
| 10 | utensil hooks |
| 11 | towel bar |
| 12 | latch |

### DETAILED DESCRIPTION

As discussed above, embodiments of the present invention relate to a cart device and more particularly to a Pit Pal that is meant to house all the accouterments necessary to the act of outdoor cooking to consolidate all the items used when barbecuing into one convenient unit, while also liberating the user from frequent trips inside the house to gather further necessities. Folding out of the way for easy storage, the multi consolidation storage utility cart referred to as Pit Pal can be conveniently stored and easily made ready when needed.

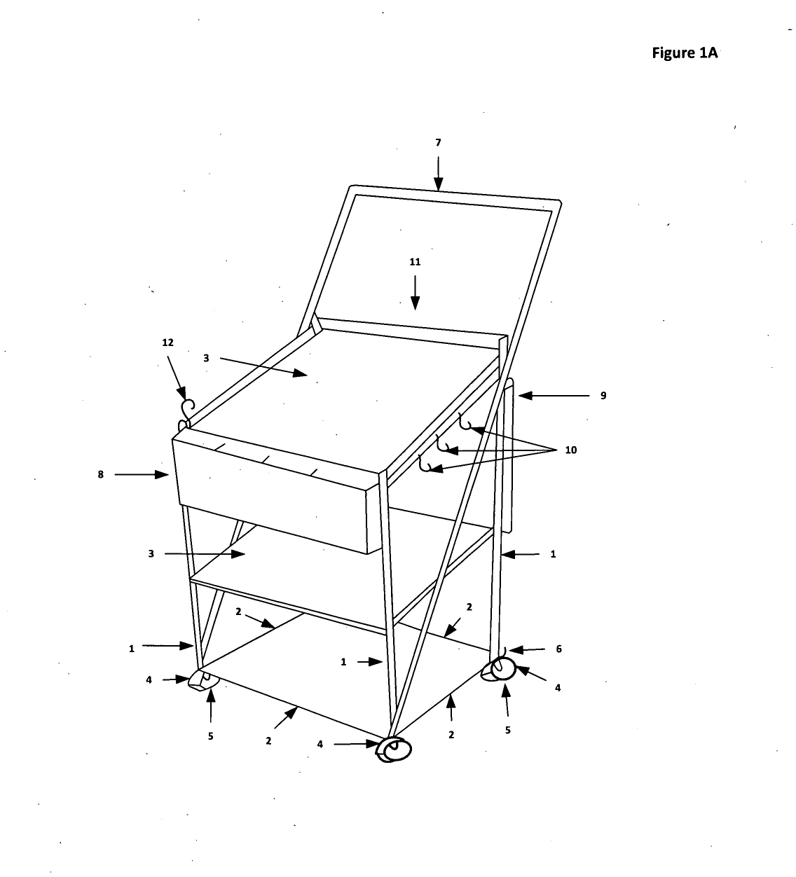

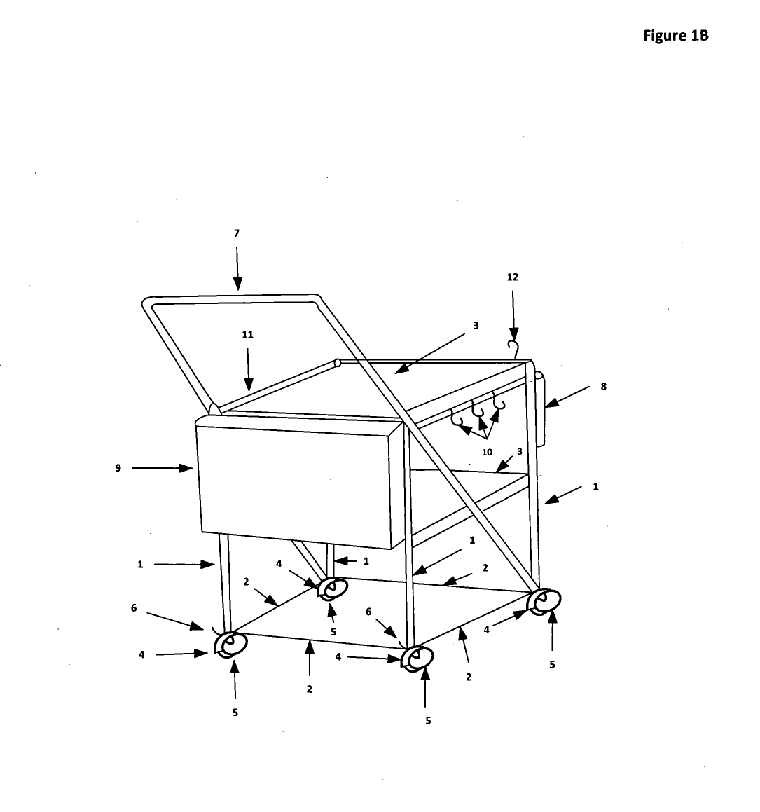

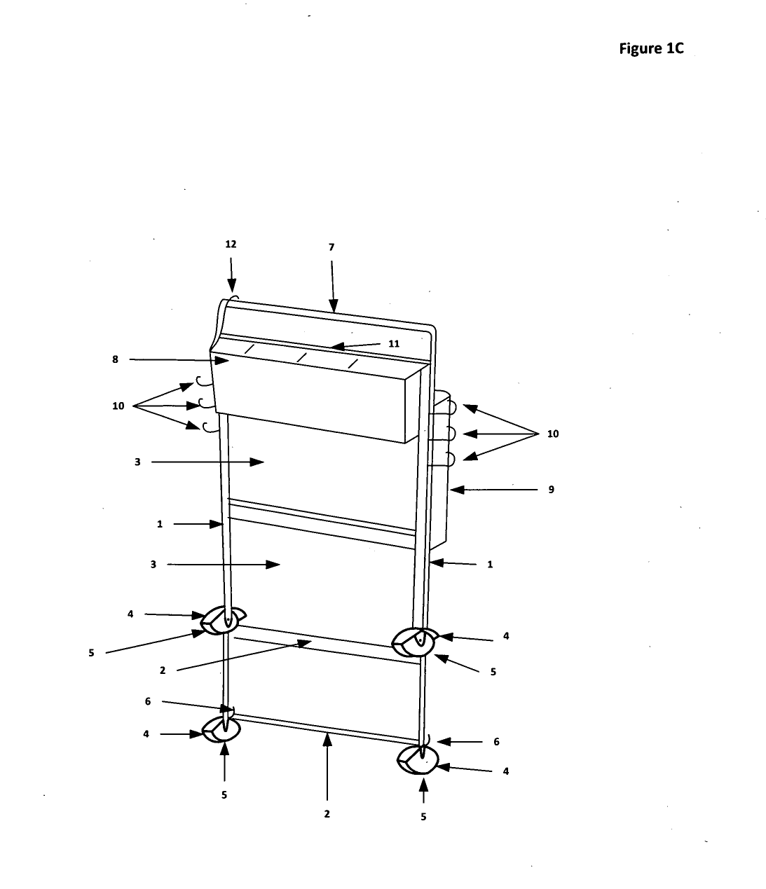

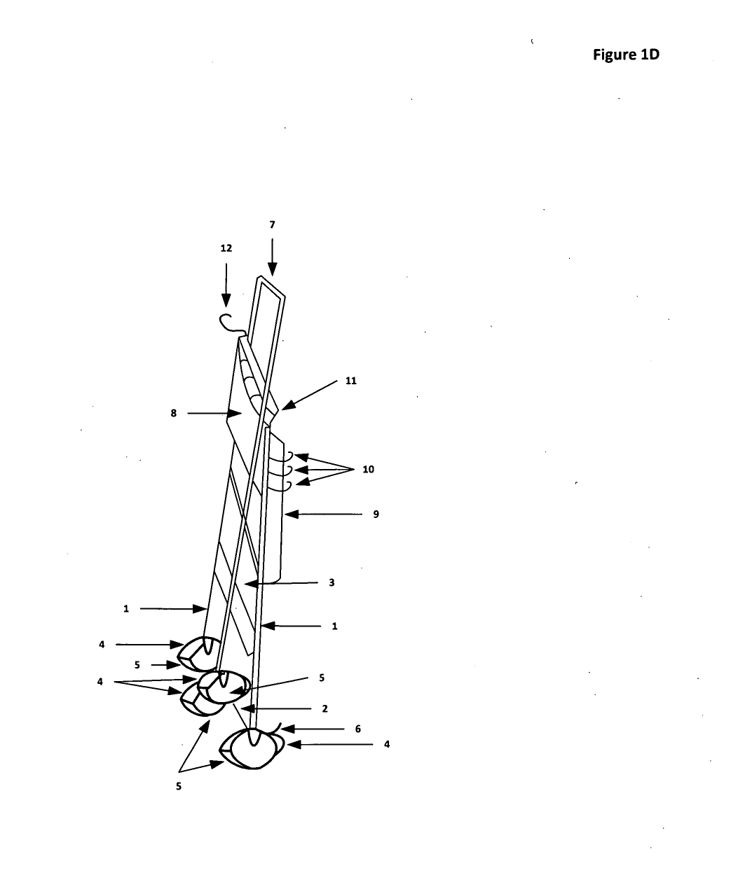

Referring now to the drawings FIG. 1A (front view), FIG. 1B (rear view) and FIG. 1C (collapsed view) and FIG. 1D (collapsed side view) the mobile multi storage utility cart comprising a novel product offering consumers a practical solution to the aforementioned challenges. As the name implies, the Pit Pal comprises a specially designed wheeled cart created to provide the ideal mobile platform for corralling and deploying outdoor cooking essentials.

The mobile multi storage utility cart would be 3′ tall, and feature a square base with sides of 2′ each when in its deployed configuration. The main vertical structural element of the device would consist of 4 vertical members (1) that rise up from the 4 corners of the base (2). These vertical members would support 2 heavy-duty, metal shelves (3), each with dimensions comparable to the base of the unit (2). The bottom of each vertical support would terminate with a plastic fitting (4) which would be attached to a small plastic wheel. (5) These wheels would be oriented around the outside of the base, 2 on each side, making the mobile multi storage utility cart easy to maneuver forward and backwards. For stability, both rear wheels would feature a small attached braking device (6) that can be toggled on or off with the toe of the foot.

A handle (7) would extend from the upper ends of the 2 rear vertical members, joining them together. This would provide an ideal control surface with which to guide the wheeled multi storage delivery system to and fro about one's grilling environment. The Pit Pal would also sport 2 baskets, 1 on the front (8) and 1 on the rear. (9) The rear basket would provide a convenient place to store aluminum foil and saran wrap, while the basket on the front would be further segmented into several compartments, making it ideal for condiment and seasoning storage. Additionally, several small hooks (10) would extend from both the left and right-hand sides of the upper shelf, providing a secure location to fasten barbecue tools and aprons. An integrated towel bar (11) would be located at the top of the unit as well.

While both shelves (3) are quite sturdy and capable of supporting heavy pots filled with food, (the top shelf intended for hot plates, hot pans and foods, and the bottom shelf for other various necessity items) they are also quite nimble, and able to fold up into the body of the device. The entire multi storage utility cart is easily collapsible with the front edge of both shelves capable of folding in and up towards the rear supporting members of the frame. A small latch (12) affixed to the front edge of the upper shelf, would connect securely to the push handle that straddles the two rear members, locking the device in the collapsed position. When this mode is engaged, the Pit Pal would present a much thinner profile, making it easy to store out of the way. Diagonal supporting members would run from the rear wheel corners up the sides of the device, to the front end of the top shelf. These would provide added lateral support, without compromising the device's ability to fold up into its collapsed configuration.

The mobile multi storage utility cart would provide 2 large, easily managed, sturdy surfaces (3) upon which various items can be placed while the outdoor cooking process is underway. A wheeled delivery system for cooking tools and utensils, condiments and other barbecue essentials, the Pit Pal would make cooking outdoors an enjoyable experience instead of repetitive, multi-tasting chore involving lots of extraneous walking. Deployed in any situation where cooking outdoors requires an assortment of tools, dishes and condiments from inside the kitchen, the fully extended mobile multi storage utility cart can easily be wheeled into the kitchen and stocked with barbecue supplies, foods, tools, condiments and accessories, and then easily maneuvered outside and adjacent to the grill. With all the necessary tools at hand, the outdoor cook could now make use of the various open surfaces, as well as all the tools and other accouterments that this useful product bears.

The Pit Pal could also be used during cleanup. When the cooking process is complete and all of the guests have eaten, the Pit Pal would make an ideal platform for gathering all of the assorted dishware, garbage and sullied cooking equipment, making it a convenient way to return these items to the confines of the kitchen. Folding out of the way for easy storage, the Pit Pal could be conveniently stored and easily at the ready when called upon. Cleverly conceived with barbecue enthusiasts in mind, the Pit Pal should receive a warm and enthusiastic market response. The Pit Pal is cost-effective to produce in the embodiments, as shown in FIG. 1A, FIG. 1B, FIG. 1C and FIG. 1D.

The embodiments of the invention described herein are exemplary. Additional accessories to the basic unit can be envisioned to achieve substantially equivalent results, all of which are intended to be embraced with in the spirit and scope of the invention. Further, the purpose of the foregoing abstract is to enable the U.S. Patent and Trademark Office and the public generally, and especially the scientist, engineers and practitioners in the art who are not familiar with patents or legal terms or phraseology, to determine quickly form a cursory inspection the nature and essence of the technical disclose of the application.

What is claimed is new and desired to be protected by Letters Patent is set forth in the appended claim:

1. A wheeled delivery system for cooking tools and utensils, condiments and other cooking essentials, providing 2 large, easily managed sturdy surfaces upon which various items can be placed while the outdoor cooking process is underway. The wheeled delivery system helps eliminate the repetitive, multi-tasking chore involving lots of extraneous walking. With all the necessary tools at hand, the outdoor cook could now make use of the various open surfaces, as well as all the tools and other accouterments that this useful product bears.

2. A wheeled delivery system that could also be used during cleanup when the cooking process is complete. The Pit Pal would make an ideal platform for gathering all of the assorted dishware, garbage and sullied cooking equipment; making it a convenient way to return these items to the confines of the kitchen. Folding out of the way for easy storage, the multi consolidation utility cart could be conveniently stored and easily at the ready when called upon.
